(19) United States
(12) Patent Application Publication
(10) Pub. No.: US 2004/0102266 A1
(43) Pub. Date: May 27, 2004

(54) Belt ratio control system for a continuously variable transmission

(76) Inventor: Shushan Bai, Ann Arbor, MI (US)

Correspondence Address: LESLIE C. HODGES, General Motors Corporation, Legal Staff, Mail Code 482-C23-B21, P.O. Box 300, Detroit, MI, 48265-3000, US

(21) Appl. No.: 10/303,531

(22) Filed: Nov. 25, 2002

(51) Int. Cl. F16H 61/00

(52) U.S. Cl. 474/18; 474/28

(57) ABSTRACT

A hydraulic control system for a continuously variable transmission (CVT) includes a ratio control valve for distributing fluid to components in the CVT. The ratio control valve receives a system controlled pressure and distributes both a high pressure control fluid and a low pressure control fluid. A variable bypass valve distributes excess fluid pressure back to the inlet of a control pump. The bypass valve is responsive to the pressure differential between the high pressure control fluid and the system pressure controlled fluid to establish the operating point at which the excess fluid is bypassed. The system pressure controlled fluid is the highest pressure in the system. During operation of the CVT, the high pressure control fluid operates on one variable sheave of the CVT and the low pressure control fluid operates on another variable sheave of the CVT. The ratio control valve is responsive to a feedback control that is effective to determine the required ratio for the CVT and therefore the desired levels of the high and low pressure control fluids.

### TECHNICAL FIELD

This invention relates to controls for continuously variable transmissions and, more particularly, to the control of the belt positioning and pressure within the continuously variable transmission control system.

### BACKGROUND OF THE INVENTION

Continuously variable transmissions (CVT), which utilize a belt drive between variable diameter sheaves, have a pressure control system, which establishes the diameter of at least one of the sheaves of the CVT.

The ratio of the CVT is controlled (in a well-known manner) by increasing the operating diameter of one sheave while decreasing the diameter of the other. This is generally accomplished through a hydraulic control system in which a positive displacement pump provides the fluid source and therefore the pressure, which operates on fluid motors on each of the variable diameter sheaves, controls the position of the sheaves.

In current CVT systems, the pressure within the control system is generally held at a level significantly higher than the pressure required to control the positioning of the variable diameter sheaves. Control systems using a fixed or high-pressure source have two disadvantages. The excess pressure of the control system at the pump reduces the overall efficiency of the transmission system. The excess flow from the pump, which is not utilized by the control system especially during fixed ratio conditions, is exhausted over the regulator valve, which causes heat increase within the transmission. This additional heat in the fluid must be cooled and therefore a larger cooling system is required.

### SUMMARY OF THE INVENTION

It is an object of the present invention to provide an improved hydraulic control system for a continuously variable transmission ratio control.

In one aspect of the present invention, a positive displacement pump supplies fluid to control the positioning of sheaves within a CVT.

In another aspect of the present invention, the pressure from the pump is distributed by a ratio control valve, which serves as both the high-pressure control system and the low-pressure control system.

In yet another aspect of the present invention, the discharge pressure of the pump is controlled by a variable bypass valve, which distributes excess fluid back to the pump inlet.

In yet still another aspect of the present invention, the bypass valve is operated or controlled by the output pressure of the pump and by the highest pressure within the CVT control system.

In a further aspect of the present invention, the pump pressure and the CVT control pressure are opposite forces on the bypass valve such that the output pressure of the pump is limited in maximum value by the maximum pressure within the belt or CVT control system.

### DESCRIPTION OF THE DRAWINGS

FIG. 1 is a schematic and diagrammatic representation of a continuously variable transmission ratio control system incorporating the present invention and having a mechanical feedback system.

FIG. 2 is a schematic and diagrammatic representation of a continuously variable transmission ratio control system incorporating the present invention and utilizing a hydraulic ratio control mechanism.

FIG. 3 is a schematic and diagrammatic representation of a bypass valve.

### DESCRIPTION OF EXEMPLARY EMBODIMENTS

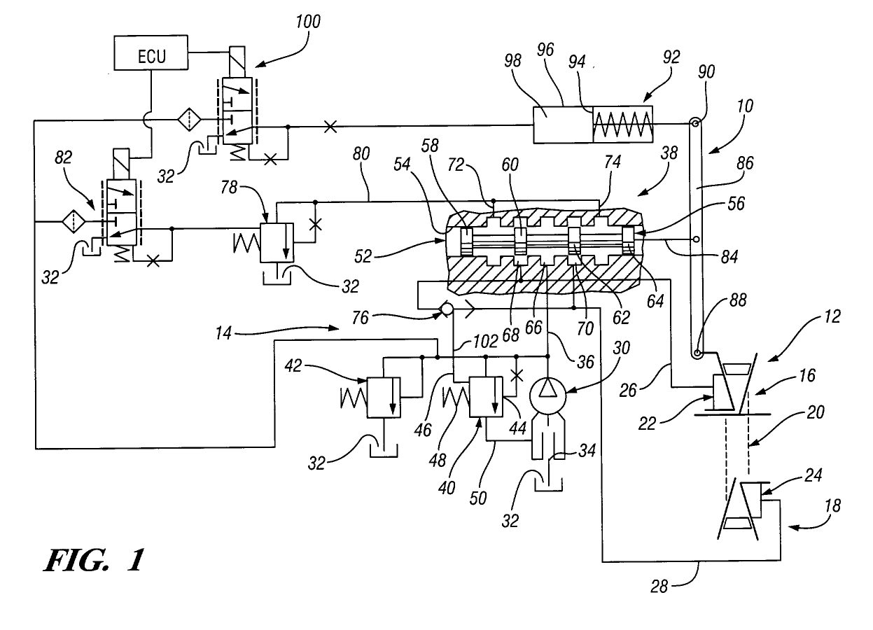

Referring to the drawings, wherein like characters represent the same or corresponding parts throughout the several views, there is seen in FIG. 1 a continuously variable transmission (CVT) ratio control system 10. The control system 10 includes a CVT 12 and a hydraulic control 14. The CVT 12 includes a pair of variable diameter sheaves or pulleys 16 and 18, which are interconnected by a flexible torque transmitter such as a belt 20. The sheave 16 includes a control chamber and piston 22 and the sheave 18 includes a chamber and control piston 24. Each of the sheaves 16 and 18 are only shown in halves to permit simplicity within the drawings. Those skilled in the art will be well aware that construction and assembly of variable diameter sheaves, such as 16 and 18, as well as the control piston and chambers 22 and 24, which are employed therewith.

The piston and chamber controls 22 and 24 are hydraulically operated devices, which receive fluid pressure through passages 26 and 28, respectively, from the hydraulic control 14. The hydraulic control 14 includes a positive displacement pump 30, which draws fluid from a reservoir 32 through a passage 34 and delivers pressurized fluid to a passage 36. The pump 30 is a conventional hydraulic device well known to those skilled in the art.

The passage 36 communicates with a ratio valve 38, a bypass valve 40, and a system relief valve 42. The system relief valve 42 is a conventional pressure regulator valve, which limits the maximum output pressure of the pump 30 in the passage 36. The bypass valve 40 is also a conventional regulator valve having a control port 44, a pilot port 46, and a bias spring 48. The bypass valve 40 is effective to return fluid from the passage 36 to a passage 50, which communicates with the inlet of the pump 30 in such a manner as to supercharge the pump inlet in a well-known manner.

The ratio valve 38 includes a valve body 52 having a bore 54 in which is slidably disposed a valve spool 56. The valve spool 56 has four lands 58, 60, 62, and 64, and the valve body 52 has an inlet port 66, a control port 68, a second control port 70, and a pair of regulated ports 72 and 74. The inlet port 66 is in continuous communication with the passage 36 and therefore the pump 30. The control port 68 is in fluid communication with the piston and chamber control 22 and with a conventional ball shuttle valve 76. The control port 70 is in fluid communication with the piston and chamber control 24 and also with the shuttle valve 76. The ports 72 and 74 are in fluid communication with a pressure regulator valve 78, which is operable to limit the pressure within the ports 72 and 74 by limiting the pressure within a passage 80, which communicates therewith.

The pressure regulator valve 78 is controlled by a force motor pilot control mechanism 82, which is a conventional electro-hydraulic device capable of providing a pressure control signal to the pressure regulator valve 78, which is variable in response to a force motor on the control 82. The force motor receives electronic signals or electrical signals from a conventional electronic control unit (ECU), not shown, which includes a preprogrammed digital computer. The control valve 82 receives inlet flow from the passage 36 to provide controlled pressure signals to the pressure regulator valve 78.

The valve spool 56 is mechanically connected through a link 84 with a control arm 86. The control arm 86 and the link 84 are part of a mechanical feedback system, which control the positioning of the valve spool 56 of the ratio valve 38. The arm 86 has a first end 88 operatively connected with the one half of the variable sheave 16 and a second end 90 operatively connected with a ratio actuator 92. The center of the arm 86 is connected with the link 84.

The ratio actuator 92 has a spring-loaded piston member 94, which cooperates with a cylinder 96 to form a chamber 98 in which control pressure is provided. The control pressure is established by a force motor regulator valve 100, which is a conventional control device similar to the control 82. The force motor regulator valve 100 also receives fluid pressure from the passage 36. The regulator valve 100 issues pressure signals to the chamber 98 to adjust the position of the piston 94 within the chamber 98. As the piston moves within the chamber 98, the end 90 of the link 86 is also moved resulting in movement of the valve spool 56. As the valve spool 56 is moved, fluid pressure is directed from the passage 36 through the valve 38 to either port 68, which is connected with the control chamber 22 or port 70, which is connected with the control chamber 24.

The ratio valve 38 is effective to connect the other of the ports 68 and 70 through the regulated ports 72 and 74. The ports 72 and 74 have a minimum pressure imposed thereon as established by the regulator valve 78. The higher pressure in either passage 26 or 28 causes an adjustment in the operating diameter of the respective sheaves 16 and 18, which results in movement of the first end 88 of the arm 86. As the arm 86 is moved with the sheave 16, the valve spool 56 will be returned to the position, which will establish the exact operating pressure required for the CVT 12. This operating pressure is determined by the ECU, which receives signals from the vehicle operator and from the vehicle.

The shuttle valve 76 is operated on by the pressure in both ports 68 and 70. The higher of these two pressures is directed through the shuttle valve 76 to a passage 102, which communicates with the port 46. The bypass valve 40 is responsive to the pressure in passage 36, the pressure in passage 102, and the bias spring 48.

The bypass valve 40 is effective to limit the pressure in passage 36 to a level determined by the highest required pressure within the belt control pressures for the CVT 12. The bypass valve 40 is closed between the passage 36 and 50 until the pressure at port 44 is equal to the pressure at port 46 plus the force of spring 48. At that time, the pressure at port 44 will cause the bypass valve to begin opening so that some of the fluid in passage 36 is bypassed back to the inlet of the pump 30. As is well known, the inlet of the positive displacement pump can be designed so that incoming flow will cause a supercharging effect at the inlet of the positive displacement pump.

If the control regulator valve 100 calls for a change in the ratio of the CVT 12, the mechanical feedback mechanism will be actuated to require a change at the ratio valve 38. This, of course, will produce a change in the pressures in passage 26 and 28, such that a change in the setting of the bypass valve 40 will also occur. If the higher pressure is required at either chamber 24 or 22, the pressure in passage 36 will increase accordingly, or if a lower pressure is demanded, then the pressure in passage 36 will decrease accordingly.

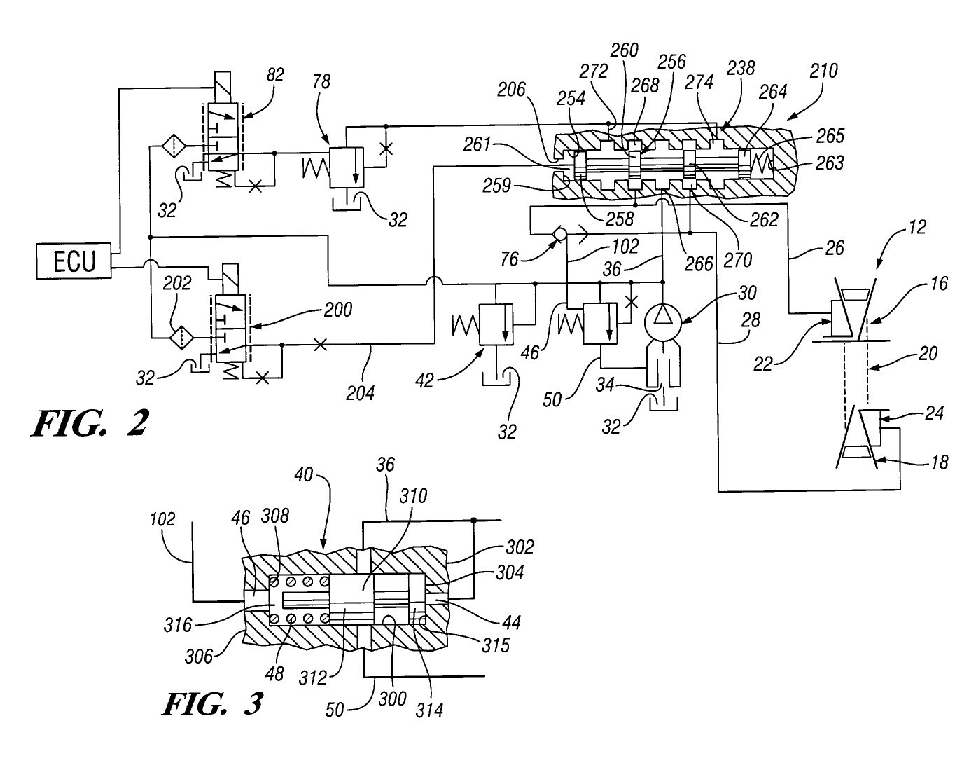

A control 210 shown in FIG. 2 is operably the same as the control 10 shown in FIG. 1. The significant difference between the controls 10 and 210 is the operation of the ratio valve 38 in FIG. 1 and 238 in FIG. 2. The ratio valve 38 requires a mechanical feedback input while the ratio valve 238 employs a hydraulic control. The hydraulic control is in the form of a force motor regulator valve 200, which is similar to the regulator valve 100. The force motor control valve 200 receives fluid pressure from passage 36 through a filter 202 and distributes the fluid pressure through a passage 204 to a port 206 on the ratio valve 238. The pressure in the passage 204 is determined by the ECU in response to operator and vehicle input signals.

The ratio valve 238 includes a valve spool 256 that is slidably disposed on a valve bore 254. The valve spool 256 has four equal diameter lands 258, 260, 262, and 264. The valve bore 254 has an inlet port 266, two belt position control ports 268 and 270, and two regulated ports 272 and 274. The port 206 is also in communication with the valve bore 254. The port 266 is in fluid communication with the passage 36, the ports 268 and 270 are in fluid communication with the passages 28 and 26, respectively, and the ports 272 and 274 are in fluid communication with the pressure regulator valve 78 which is controlled by the force motor control valve 82.

The valve land 258 cooperates with an end 259 of the valve bore 254 to form a chamber 261, which when pressurized will urge the valve spool 258 rightward. The valve land 264 cooperates with an end 263 of the valve bore 254 to form a chamber in which a spring 265 is disposed. The spring 265 urges the valve spool 256 leftward in the valve bore 254 in opposition to the pressure in the chamber 261.

The force motor regulator valve 200 issues pressure signals to the chamber 261 in response to the operating condition set by the operator as well as the vehicle operating parameters. The fluid in chamber 261 cooperates with the spring 265 to position the valve spool 256 in the valve bore 254. Depending upon the position that is established by these operating conditions, the fluid pressure in passage 36 is delivered to one of the passages 26 and 28 at a higher pressure level than the other passage. The lower pressure passage of passages 26 and 28 is controlled by the pressure regulator valve 78. The higher pressure in one of the passages is directed to the respective control chambers and pistons 22 and 24 for the sheaves 16 and 18 so that the ratio of the CVT 12 is properly adjusted.

As with the control system of FIG. 1, the bypass valve 40 will establish a position in which the pressure in passage 36 is equal to the pressure in passage 102 plus the force of the spring 48. Thus, the maximum pressure in the control system is maintained at a level slightly greater than the maximum control system pressure required by the CVT 12. Any excess fluid delivered by the pump 30 is bypassed by the valve 40 back to the pump inlet, which improves the operating condition and efficiency of the pump 30.

A diagrammatic example of the bypass valve 40 is shown in FIG. 3. As seen in FIG. 3, the bypass valve 40 includes a valve bore 300 formed in a valve body 302. The valve body 302 is closed at end 304 and has a cover 306 closing an end 308. A valve spool 310 is slidably disposed in the valve bore 300. The valve spool 310 has two equal diameter lands 312 and 314. The valve land 314 operates with the end 304 of the valve bore 300 to form a pressure chamber 315, which is in fluid communication with the port 44 and therefore the passage 36. The valve land 312 cooperates with the end 308 to form a chamber 316 in which a spring 318 is disposed to urge the valve spool 310 rightward in the valve bore 300. The chamber 316 is also in fluid communication with the passage 102 through the port 46.

The valve land 312 also controls fluid communication between the passages 36 and 50. In the position shown (the full rightward position), the passage 36 is closed to the passage 50. The valve spool 310 is held in this position until the pressure in passage 36 at port 44 is sufficient to urge the valve spool 310 rightward to overcome the opposing forces in chamber 316 and spring 318. When this occurs, the valve spool 310 is moved leftward until the passage 36 is controllably communicated to the passage 50 such that the pressure in passage 36 will not rise further unless there is a further increase in the pressure in passage 102. When the pressure in passage 102 decreases, the pressure in chamber 315 will cause the valve spool 310 to move sufficiently to permit further increased fluid communication between passages 36 and 50 such that the pressure in passage 36 will decrease. The valve spool 310 will assume a new control position when the pressures in chambers 315 and 316 and the force in the spring 48 are again in balance.

Obviously, there are a number of different designs for bypass valves, which will satisfy the present invention. Also in the present invention, as set forth above, the areas of valve lands 314 and 312 are equal, therefore the pressure in the chambers 315 and 316 will have an equal effect in changing the position of the valve spool 310. The pressure difference between the chambers 315 and 316 is determined by the force in spring 318. This differential can, of course, be determined by dividing the numerical value of the force in spring 318 by the area of the valve land 314.

In one example of the control system, this bias is set at 15 psi. Thus, the pressure in passage 36 will be 15 psi higher than the pressure in passage 102. When the bypass valve 40 is regulated, the pressure in passages 102 and 36 will change accordingly. Any change in the pressure in passage 102 is reflected by an equal change in the pressure in passage 36. The pressure in passage 102 will always be equal to the higher pressure required in the piston and chambers 22 and 24. Thus, the output pressure of the pump 30 represented by the pressure in passage 36 will always be slightly higher than the maximum control pressure required by the CVT 12. Those skilled in the art will recognize that the areas of the chambers 315 and 316 do not have to be equal. If they are unequal, a ratio of other than one-to-one will be present between the pressure in the passages 36 and 102.

1. A ratio control system for a continuously variable transmission having first and second variable sheave assemblies interconnected by a flexible drive member comprising:
a source of system pressure;
a ratio control valve disposed in fluid communication with said source including a valve member operable to distribute fluid independently to said first and second variable sheaves to establish a drive ratio therebetween, said distributed fluid having first and second pressure level with said first pressure level being higher than said second pressure level; and
a bypass valve means having a first control area in fluid communication with said source and a second control are in fluid communication with said first pressure level to produce a first force in opposition to a second force established by said system pressure and spring means cooperating with said second control area, said bypass valve means distributing excess fluid from said source to a return passage when said spring means and said first force are sufficient of overcome said second force.

2. The ratio control system defined in claim 1 further comprising:
control means for establishing said drive ratio; and
control means for establishing said second pressure level.

3. The ratio control system defined in claim 1 further comprising:
valve means for directing said first pressure level fluid to said bypass valve means.

4. The control system defined in claim 2 further comprising:
valve means responsive to said first pressure level fluid and said second pressure level fluid to direct said first pressure level fluid to said bypass valve means.

5. A ratio control system for a continuously variable transmission having first and second variable sheave assemblies interconnected by a flexible drive member comprising:
a source of system pressure;
a ratio control valve disposed in fluid communication with said source including a valve member operable to distribute fluid a first pressure level fluid and a second pressure level fluid independently to said first and second variable sheaves to establish a drive ratio therebetween, one of said first and second pressure level fluids being higher than the other; and
a bypass valve means having a first control area in fluid communication with said source to establish a first force and a second control area in fluid communication with said higher of said first and second pressure level fluids to produce a second force in opposition to said first force established by said system pressure, and spring means cooperating with said second force, said bypass valve means distributing excess fluid from said source to a return passage when said spring means and said second force are sufficient of overcome said first force.

6. The ratio control system defined in claim 5 further comprising:
valve means responsive to said first and second pressure level fluids to direct the higher of said first and second pressure level fluids to said second control area.

7. The ratio control system defined in claim 5 further comprising:
control means for establishing said drive ratio; and
control means for establishing said second pressure level.

8. The ratio control system defined in claim 6 further comprising:
control means for establishing said drive ratio; and
control means for establishing said second pressure level.
